(19) United States
(12) Patent Application Publication
(10) Pub. No.: US 2002/0087309 A1
(43) Pub. Date: Jul. 4, 2002

(54) Computer-implemented speech expectation-based probability method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/864,045

(22) Filed: May 23, 2001

Related U.S. Application Data
(60) Provisional application No. 60/258,911, filed on Dec. 29, 2000.

(51) Int. Cl. G10L 15/12; G10L 15/08; G10L 15/00

(52) U.S. Cl. 704/240

(57) ABSTRACT

A computer-implemented system and method for speech recognition of a user speech input. A language model is used to contain probabilities used to recognize speech, and an application domain description data store contains a mapping between pre-selected words and domains. A probability adjustment unit selects at least one domain based upon the user speech input. The probability adjustment unit adjusts the probabilities of the language model to recognize the user speech input based upon the words that are mapped to the selected domain.

### RELATED APPLICATION

This application claims priority to U.S. Provisional Application Serial No. 60/258,911 entitled “Voice Portal Management System and Method” filed Dec. 29, 2000. By this reference, the full disclosure, including the drawings, of U.S. Provisional Application Serial No. 60/258,911 is incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in telephony computer service applications because they are a more natural way for information to be acquired from people. For example, speech recognition systems are used in telephony applications where a user through a communication device requests that a service be performed. The user may be requesting weather information to plan a trip to Chicago. Accordingly, the user may ask what is the temperature expected to be in Chicago on Monday.

A traditional speech recognition system associates the keywords (such as “Chicago”) with recognition probabilities. A difficulty with this approach is that the recognition probabilities remain fixed despite the context of the user's request changing over time. Also, a traditional speech recognition system uses keywords that are updated through a time-consuming and inefficient process. This results in a system that is relatively inflexible to capture the ever-changing colloquial vocabulary of society.

The present invention overcomes these disadvantages as well as others. In accordance with the teachings of the present invention, a computer-implemented system and method are provided for speech recognition of a user speech input. A language model is used to contain probabilities used to recognize speech, and an application domain description data store contains a mapping between pre-selected words and domains. A probability adjustment unit selects at least one domain based upon the user speech input. The probability adjustment unit adjusts the probabilities of the language model to recognize the user speech input based upon the words that are mapped to the selected domain. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used by the present invention to recognize user input speech;

FIG. 2 is a word sequence diagram depicting N-best search results with probabilities that have been adjusted in accordance with the teachings of the present invention;

FIG. 3 is a data diagram depicting exemplary semantic and syntactic data and rules;

FIG. 4 is a probability propagation diagram depicting semantic relationships constructed through serial and parallel linking;

FIG. 5 is an exemplary application domain description data set that depicts words whose probabilities are adjusted in accordance with the application domain description data set;

FIG. 6 is a block diagram depicting the web summary knowledge database for use in speech recognition;

FIG. 7 is a block diagram depicting the conceptual knowledge database unit for use in speech recognition;

FIG. 8 is a block diagram depicting the user profile database for use in speech recognition; and

FIG. 9 is a block diagram depicting the phonetic similarity unit for use in speech recognition.

### DETAILED DESCRIPTION OF THE PREFERRED EMBODIMENT

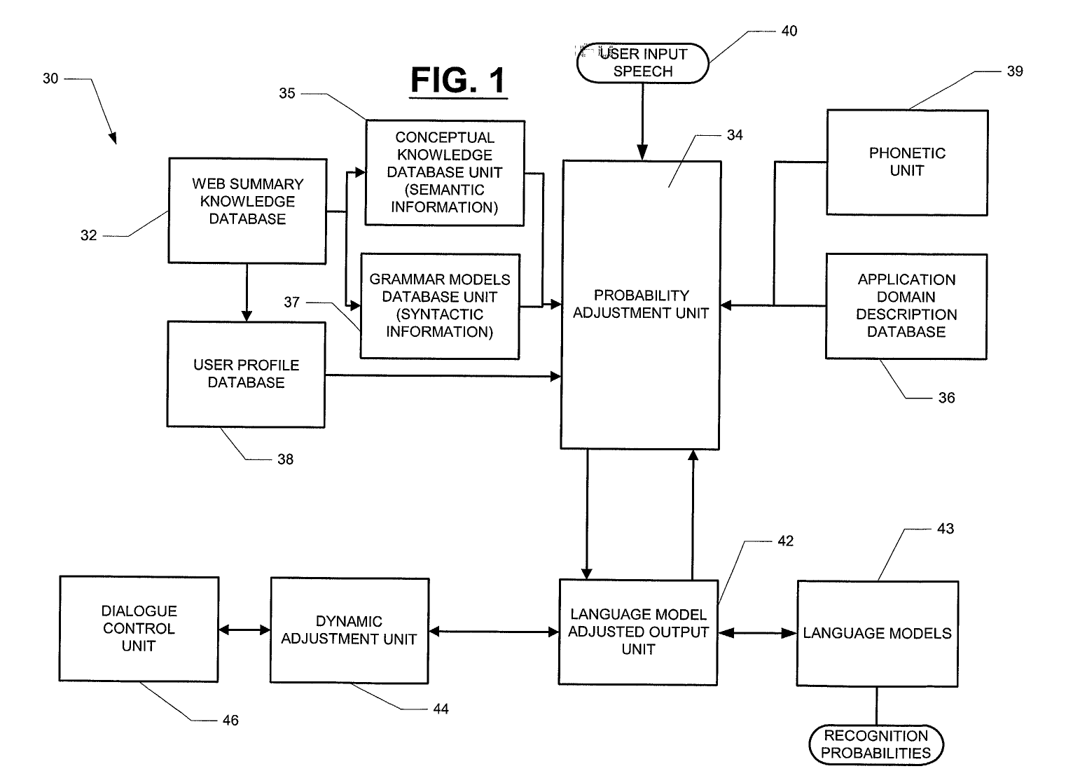

FIG. 1 depicts the expectation-based probability adjustment system 30 of the present invention. The system 30 makes real time adjustments to speech recognition language models 43 based upon the likelihood that certain words may occur in the user input speech 40. Words that are determined to be unlikely to appear in the user input speech 40 are eliminated as predictable irrelevant terms. The system 30 builds upon its initial prediction capacity so that it decreases the time taken to decode the user input speech 40 and reduces inappropriate responses to user requests.

The system 30 includes a probability adjustment unit 34 to make predictions about which words are more likely to be found in the user input speech 40. The probability adjustment unit 34 uses both semantic and syntactic approaches to make adjustments to the speech recognition probabilities contained in the language models 43. Other data, such as utterance length of the user speech input 40, also contribute to the probability adjustments.

Semantic information is ultimately obtained from Internet web pages. A web summary knowledge database 32 analyzes Internet web pages for which words are most frequently used. The conceptual knowledge database unit 35 uses the word frequency data from the web summary knowledge database 32, to determine which words most frequently appear with each other. This frequency defines the semantic relationships between words that are stored in the conceptual knowledge database unit 35. The user profile database 38 contains information about the frequency of use of terms found in previous user requests.

The grammar models database unit 37 stores syntactic information for predicting the structure consisting of nouns, verbs, and adjectives in a sentence of the user input speech 40. The grammar models database unit 37 contains predefined syntactic relationship structures, obtained from the web summary knowledge database 32. This further assists its prediction by applying these relationship structures. The probability adjustment unit 34 dynamically adjusts its prediction based on the words it is encountering. Thus, it is able to select which words in the language models 43 to adjust, based on its prediction of nouns, verbs and adjectives. By using a co-related semantic and syntactic modeling technique, the probability adjustment unit 34 influences the weighting, scope and nature of the adjustment to the language models' probabilities.

For example, the probability adjustment unit 34 determines the likelihood that words will appear in the user input speech 40 by pooling semantic and syntactic information. For example, in the utterance: “give the weather . . . ”, the word “weather” is the pivot word, which is used to initiate predictions and adjustments of the language models 43. A list of all possible recognitions for “weather” (such as “waiter”) defines all words that have phonetic similarity. Phonetic similarity information is provided by the phonetic unit 39. The phonetic unit 39 picks up all recognized words with similar pronunciation. A probability value is assigned to each of the possible pivot words, to indicate the certainty of such recognition. A threshold is then used to filter out low probability words, whereas other words are used to make further prediction. The pivot words are used to establish the domain of the user input speech, such as the word “weather” or “waiter” in the example. An application domain description database 36 contains the corpus of terms that are typically found within a domain as well as information about the frequency of use of specific words within a domain. Domains are topic-specific, such as a computer sprinter domain or a weather domain. A computer printer domain may contain such words as “refill-ink” or “output”. A weather domain may contain such words as “outdoor”. A food domain may contain such words as “waiter”. The application domain description database 36 associates words with domains. For each pivot word in turn, the domain is identified. Words that are associated with the currently selected domain have their probabilities increased. The conceptual knowledge database unit 35 and grammar models database unit 37 are then used to select the most appropriate outcome combination, based on its overall semantic and grammatical relationships.

The probability adjustment unit 34 communicates with a language model adjusted output unit 42 to adjust the probabilities of the language models 43 for more accurate predictions. The language model adjusted output unit 42 is calibrated by the dynamic adjustment unit 44. The calibration is performed by the dynamic adjustment unit 44 receiving information from the dialogue control unit 46. The dynamic adjustment unit 44 accesses the dialogue control unit 46 for information on the dialogue state to further control the probability adjustment. The dialogue control unit 46 uses a traditional state-graph model to enable interpretation of each input utterance to formulate a response.

The language models 43 may be any type of speech recognition language model, such as a Hidden Markov Model. Hidden Markov Models are described generally in such references as “Robustness In Automatic Speech Recognition”, Jean Claude Junqua et al., Kluwer Academic Publishers, Norwell, Mass., 1996, pages 90-102. The models in the language models unit 36 are of varying scope. For example, one language model may be directed to the general category of printers and includes top level product information to differentiate among various computer products such as printer, desktop, and notebook. Other language models may include more specific categories within a product. For example for the printer product, specific product brands may be included in the model, such as Lexmark® or Hewlett-Packard®.

As another example, if the user requests information on refill ink for a brand of printer, the probability adjustment unit 34 raises the probability of printer-related words and assembles printer-related subsets to create a language model. A language model adjusted output unit 42 retrieves a language model subset of printer types and brands, and the subset is given a higher probability of correct recognition. Depending on the relevance to a domain of application, specific words in a language model subset may be adjusted for accurate recognition. Their degree of probability may be predicted based on domain, degree of associative relevance, history of popularity, and frequency of past usage by the individual user.

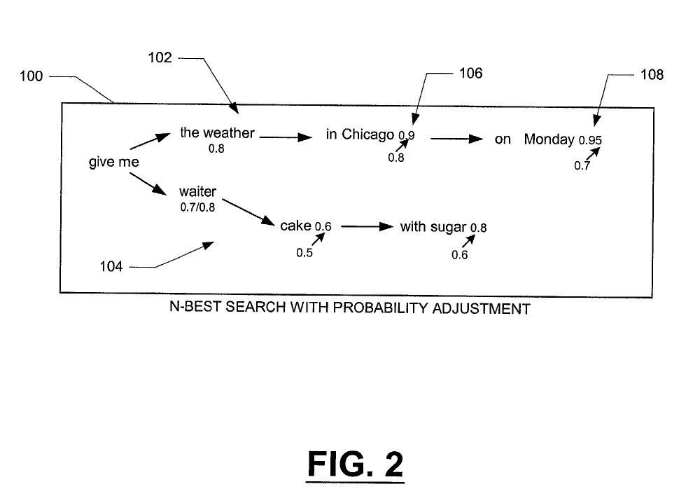

FIG. 2 depicts the dynamic probability adjustment process with an example “give me the weather in Chicago on Monday”. Box 100 depicts how the speech recognizer generates all the possible “best” hypothesized results. Once “weather” and “waiter” are heard as first and second hypotheses (102, 104), the search first favors “weather” and adjusts higher the probabilities of “City” and “Day” related words, reflecting the expectation based on conceptual and syntactic knowledge gathered from the web. As indicated by reference numeral 106 the City word “Chicago” has its probability increased from 0.8 to 0.9. The Day word “Monday” has its probability increased from 0.7 to 0.95. The probabilities of words in the “food” domain remain unchanged (that is, 0.7, 0.6, 0.5) unless the first hypothesis is refuted, (for example, in the case that the expected City and Day words cannot be found with high enough phonetic matching score). In this case, the second hypothesis is tried, and the probabilities of the food words are raised and the City and Day words are changed back to their original probabilities in the language model.

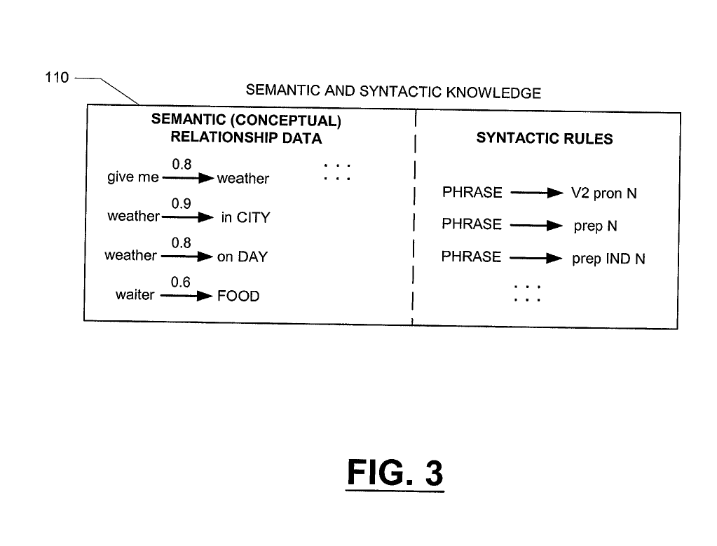

FIG. 3 depicts exemplary semantic and syntactic data used by the present invention to adjust the language models' probabilities. Box 110 depicts the knowledge gathered from the web in the form of conceptual relations between words and syntactic structures (phrase structures). Such knowledge is used to make predictions of word sequences and probabilities in language models.

Semantic knowledge (as is stored in the conceptual knowledge database unit) is depicted in FIG. 3 by the conceptual relatedness metric used with each pair of concepts. For example based upon analysis of Internet web pages, it is determined that the concept “weather” and “city” are highly interrelated and have a conceptual relatedness metric of 0.9. Syntactic knowledge (as is stored in the grammar models database unit) is also used by the present invention. Syntactic knowledge is expressed through syntactic rules. For example, a syntactic rule may be of the form “V2 pron N”. This exemplary syntactic rule indicates that it is proper syntax if a bi-transitive verb is followed by two objects, such as in the statement “give me the weather”. The word “give” corresponds to the symbol “V2”, the word “me” corresponds to the (indirect) object symbol “pron”, and the word “weather” corresponds to the (direct) object symbol “N”.

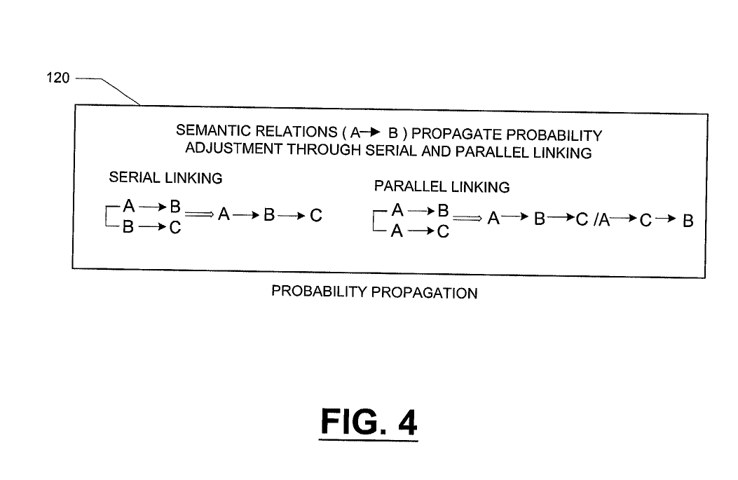

FIG. 4 is a probability propagation diagram that depicts semantic relationships constructed through serial and parallel linking. Box 120 depicts the probability propagation mechanism. This makes probability adjustment effects propagate from one pair of conceptual relation to a series of relations. This indicates that the more information obtained from the earlier part of the sentence, the higher the certainty will be for the remaining portion of the user input speech. In this situation, even higher probabilities are assigned to the expected words once the earlier expectations are met. This is realized by assigning probabilities to pairs of conceptual relation rules, according to the information of co-occurrence of conceptual relations. This is called “second-order probabilities”. By this mechanism, two conceptual relations are linked either in serial or in parallel in order to predict long sequences of words with more certainty by propagating word probabilities in earlier parts of the utterance forward. If the probability of some earlier words (e.g. “weather”) passes a threshold, then the probability of later words in a predicted series may be raised even higher (for example, with reference to FIG. 2, the Day words were raised to 9.95 as shown by reference numeral 108 due to the earlier occurrence of the term “weather” as well as the term “Chicago”).

This propagation mechanism avoids the problem of combination explosion of conceptual sequences. This also makes the system more powerful than the n-gram model of traditional systems, because the usual n-gram model does not propagate probabilities from one rule to others. The reason is that the usual n-gram models do not have the second-order probabilities.

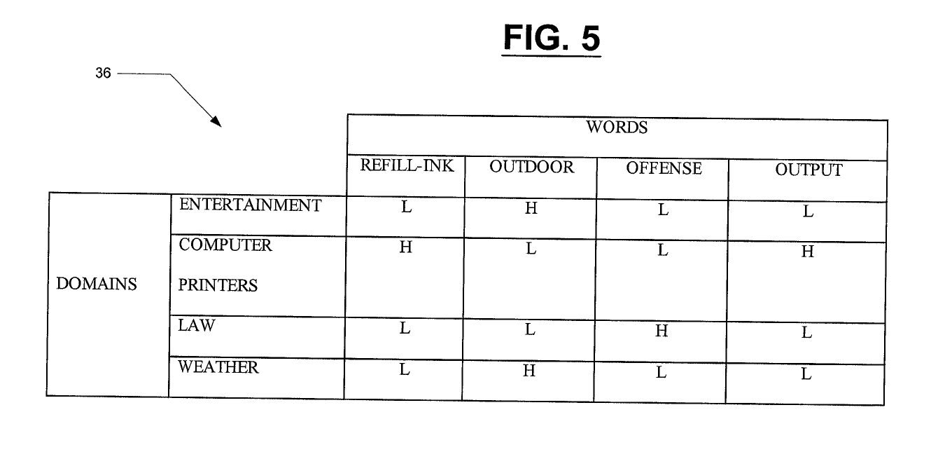

FIG. 5 shows an example of an application domain description database 36. The application domain description database 36 indicates which words with respect to a domain are accorded a higher probability weight. For example, consider the scenario wherein a user asks “Do you sell refill-ink for Lexmark Z11 printers?”. The present invention, after recognizing several words using a general products language model determines “printer” is a domain related to the user's request. The application domain description database 36 indicates which words are associated with the domain “printer” and these words are accorded a higher weight.

A letter “H” in the table designates that a word is to be accorded a high probability if the user's request concerns its associated domain. The letter “L” designates that a low probability should be used. Due to the high probability designation for pre-selected words in the printer domain, the probability of the printer-associated words are increased such as “refill-ink”. It should be understood that the present invention is not limited to only using a two state probability designation (i.e., high and low), but includes using a sufficient number of state designations to suit that application at hand. Moreover, numeric probabilities may be used to better distinguish which the adjustment probabilities should be used for words word within a domain.

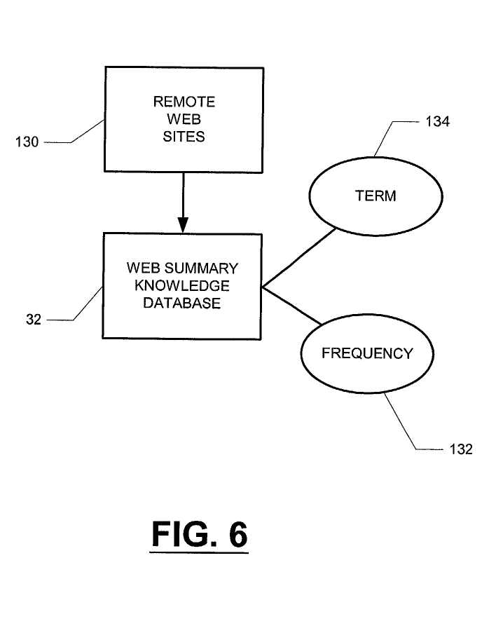

FIG. 6 depicts the web summary knowledge database 32. The web summary information database 32 contains terms and summaries derived from relevant web sites 130. The web summary knowledge database 32 contains information that has been reorganized from the web sites 130 so as to store the topology of each site 130. Using structure and relative link information, it filters out irrelevant and undesirable information including figures, ads, graphics, Flash and Java scripts. The remaining content of each page is categorized, classified and itemized. Through what terms are used on the web sites 130, the web summary database 32 determines the frequency 132 that a term 134 has appeared on the web sites 130. For example, the web summary database may contain a summary of the Amazon.com web site and determines the frequency that the term golf appeared on the web site.

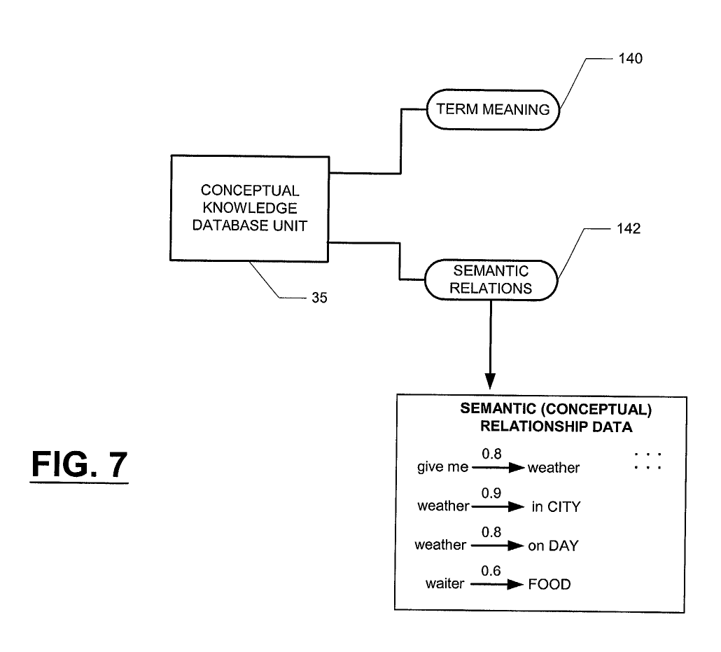

FIG. 7 depicts the conceptual knowledge database unit 35. The conceptual knowledge database unit 35 encompasses the comprehension of word concept structure and relations. The conceptual knowledge unit 35 understands the meanings 140 of terms in the corpora and the semantic relationships 142 between terms/words.

The conceptual knowledge database unit 35 provides a knowledge base of semantic relationships among words, thus providing a framework for understanding natural language. For example, the conceptual knowledge database unit may contain an association (i.e., a mapping) between the concept “weather” and the concept “city”. These associations are formed by scanning web sites, to obtain conceptual relationships between words and categories, and by their contextual relationship within sentences.

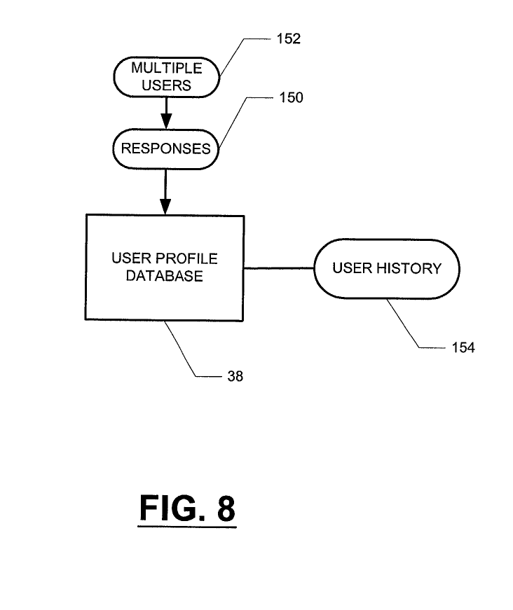

FIG. 8 depicts the user profile database 38. The user profile database 38 contains data compiled from multiple users' histories that has been calculated for the prediction of likely user requests. The histories are compiled from the previous responses 150 of the multiple users 152. The response history compilation 154 of the user profile database 38 increases the accuracy of word recognition. Users belong to various user groups, distinguished on the basis of past behavior, and can be predicted to produce utterances containing keywords from language models relevant to, for example, shopping or weather related services.

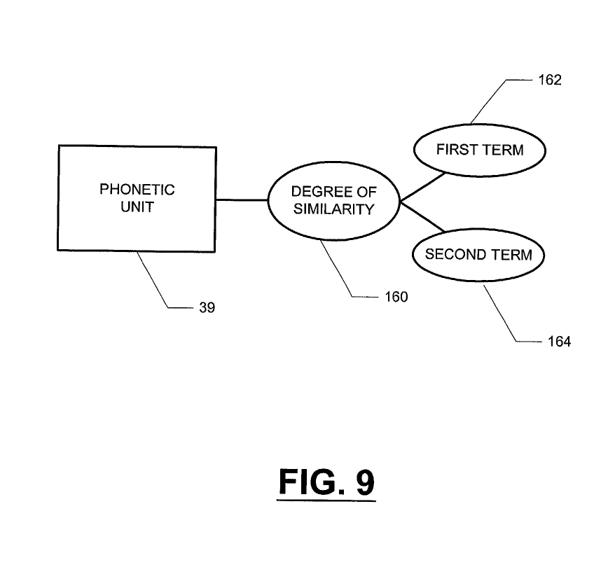

FIG. 9 depicts the phonetic unit 39. The phonetic unit 39 encompasses the degree of phonetic similarity 160 between pronunciations for two distinct terms 162 and 164. The phonetic unit 39 understands basic units of sound for the pronunciation of words and sound to letter conversion rules. If, for example, a user requested information on the weather in Tahoma, the phonetic unit 39 is used to generate a subset of names with similar pronunciation to Tahoma. Thus, Tahoma, Sonoma, and Pomona may be grouped together in a specific language model for terms with similar sounds.

The preferred embodiment described within this document with reference to the drawing figure is presented only to demonstrate an example of the invention. Additional and/or alternative embodiments of the invention will be apparent to one of ordinary skill in the art upon reading this disclosure.

It is claimed:

1. A computer-implemented system for speech recognition of a user speech input, comprising:
a language model that contains probabilities used to recognize speech;
an application domain description data store that contains a mapping between pre-selected words and domains;
a probability adjustment unit connected to the application domain description data store that selects at least one domain based upon the user speech input, said probability adjustment unit adjusting the probabilities of the language model to recognize the user speech input based upon the words that are mapped to the selected domain.
